(19) United States
(12) Patent Application Publication
(10) Pub. No.: US 2017/0050575 A1
(43) Pub. Date: Feb. 23, 2017

(54) Vehicle Mounted Holster

(71) Applicant: Jonathan Dara, Knightdale, NC (US)

(72) Inventor: Jonathan Dara, Knightdale, NC (US)

(21) Appl. No.: 15/243,755

(22) Filed: Aug. 22, 2016

Related U.S. Application Data
(63) Continuation-in-part of application No. 29/567,815, filed on Jun. 13, 2016.
(60) Provisional application No. 62/208,030, filed on Aug. 21, 2015.

(51) Int. Cl. B60R 7/14; F41C 33/02; F41C 33/04

(52) U.S. Cl. CPC B60R 7/14; F41C 33/045; F41C 33/0236

(57) ABSTRACT

A vehicle mounted holster is used to position a firearm to the interior of a vehicle to be conveniently accessed by a user when necessary. The vehicle mounted holster secures the firearm to the interior of the vehicle in order to prevent accidental discharge during transportation. The vehicle mounted holster includes a firearm holster and a mounting fixture. The mounting fixture connects the firearm holster to the interior of a vehicle in order for the firearm holster to be conveniently accessibly by the user. Through the incorporation of a first ball-and-socket joint the user is able to rotate the firearm holster about the mounting fixture in order to accessibly position the firearm holster.

The current application claims a priority to the U.S. Provisional Patent application Ser. No. 62/208,030 filed on Aug. 21, 2015. The current application is filed on Aug. 22, 2016 while Aug. 21, 2015 was on a weekend.

### FIELD OF THE INVENTION

The present invention relates generally to firearm holsters. More specifically, the present invention is a firearm holster that attaches to the interior of a vehicle.

### BACKGROUND OF THE INVENTION

Firearm holsters are generally devices to secure a handgun on a person to allow the person to have easy access to the handgun. The firearm holster provides safety for the user by covering the trigger of a handgun in order to prevent the accidental discharge of the handgun. The firearm holster allows the handgun to be accessed for immediate use and is typically fastened to a user's belt, waistband, ankle, thigh, or torso. While these locations are convenient, having the handgun attached to your person is not always desirable.

Therefore, it is an objective of the present invention to provide a firearm holster that is able to be mounted to the interior of a vehicle. While there have been interior mounting firearm holsters, the present invention allows the firearm holster to be positioned at varying angles to the interior of the car such that the handgun is easily accessible. The firearm holster is able to be disconnected from a holster support that is fixed to the interior of the vehicle to allow the firearm holster to be transported on the user's person when leaving the vehicle. The user is able to easily fasten the firearm holster to the holster support when the user returns to the vehicle.

### BRIEF DESCRIPTION OF THE DRAWINGS

FIG. 1 is a perspective view of the present invention.

FIG. 2 is an exploded side view of the present invention, wherein the mounting support is a bracket.

FIG. 3 is an assembled side view of the present invention, wherein the mounting support is a bracket.

FIG. 4 is an exploded view of the present invention, wherein the mounting support is a tubular support clamp.

FIG. 5 is a top view of present invention, wherein the holster body is positioned to a ninety-degree angle with the mounting support.

### DETAIL DESCRIPTIONS OF THE INVENTION

All illustrations of the drawings are for the purpose of describing selected versions of the present invention and are not intended to limit the scope of the present invention.

The present invention is a vehicle mounted holster. The present invention allows a firearm, most commonly a handgun, to be mounted to the interior of a vehicle to be conveniently accessed by a user when necessary. The present invention secures the firearm to the interior of the vehicle in order to prevent accidental discharge during transportation. The present invention is preferred to be molded from a thermoplastic acrylic-polyvinyl chloride (PVC) sheet in order to provide structural support for supporting the firearm as well as preventing the actuation of a trigger for the firearm through the present invention.

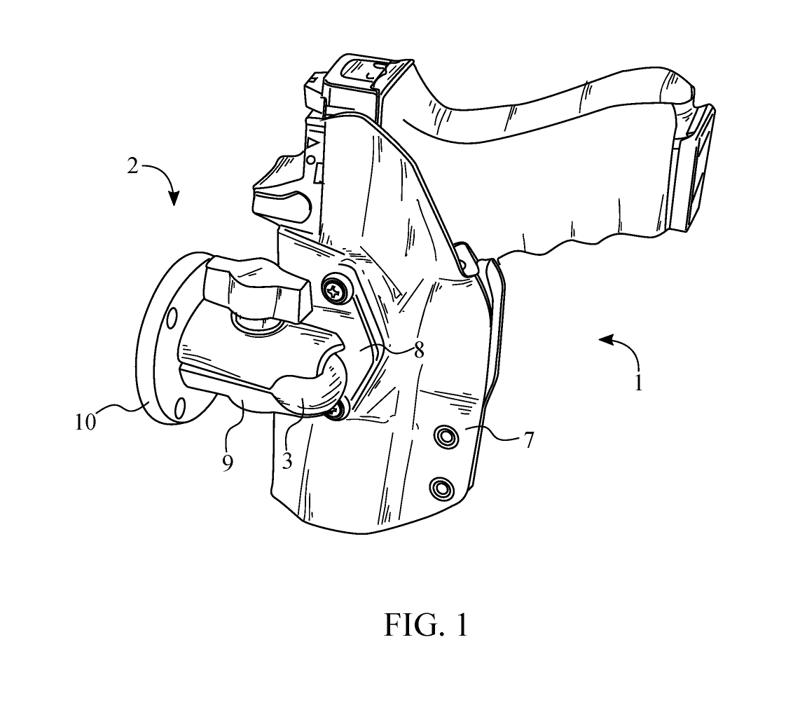

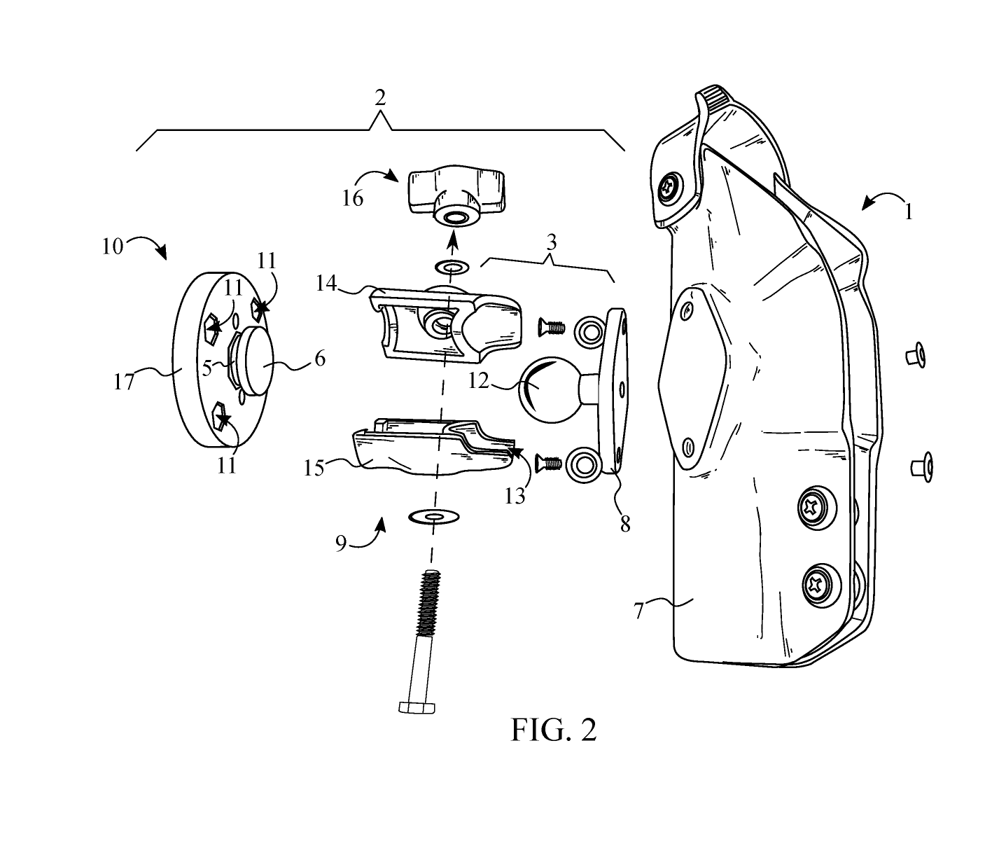

In accordance to FIG. 1 and FIG. 2, the present invention comprises firearm holster 1, a mounting fixture 2 and a first ball-and-socket joint 3. The firearm holster 1 directly supports the firearm and restrains the firearm from being accidently discharged due to inadvertent initiation for a firing mechanism of the firearm. The firearm holster 1 comprises a holster body 7 and a mounting plate 8. The holster body 7 receives the firearm while the mounting plate 8 secures the firearm holster 1 to the mounting fixture 2. The mounting plate 8 is laterally integrated into the holster body 7. The mounting plate 8 is preferred to be centrally positioned along the holster body 7 in order to evenly support the firearm holster 1 on the holster support 9. The position of mounting plate 8 also prevents interference from the mounting plate 8 and the mounting fixture 2 as the user accesses or stores the firearm during implementation of the present invention. The mounting fixture 2 supports the firearm holster 1, and subsequently the firearm, to the interior of a vehicle. The mounting fixture 2 comprises a holster support 9 and a mounting support 10. The holster support 9 provides retains the position of the firearm holster 1, while the mounting support 10 directly mounts the present invention to the interior of the vehicle. The holster support 9 is adjacently connected to the mounting support 10 in order to support the firearm holster 1 onto the interior of the vehicle. The holster support 9 is preferred to be centrally positioned on the mounting support 10 in order for the weight of the present invention to be supported on the interior of the vehicle.

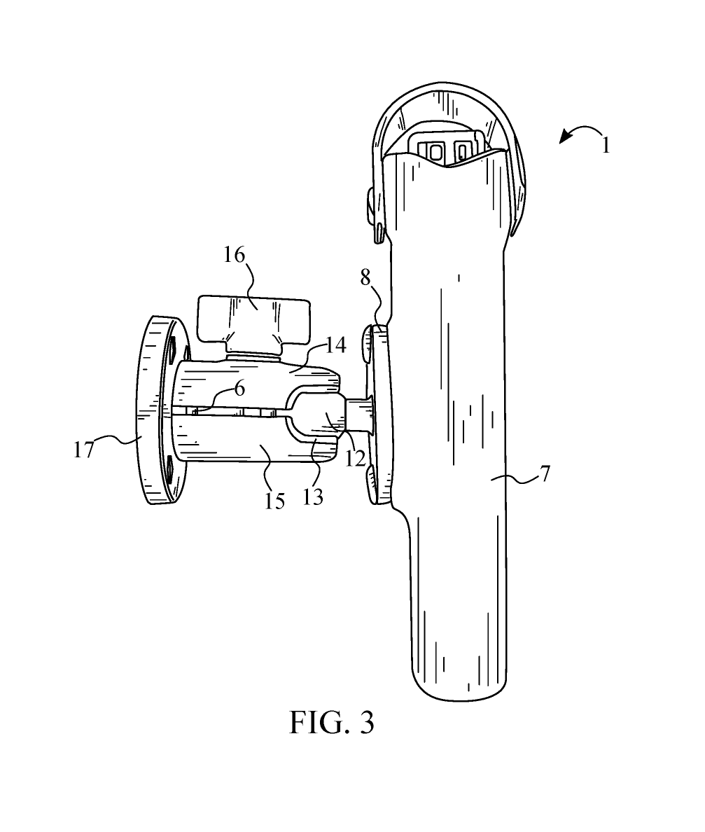

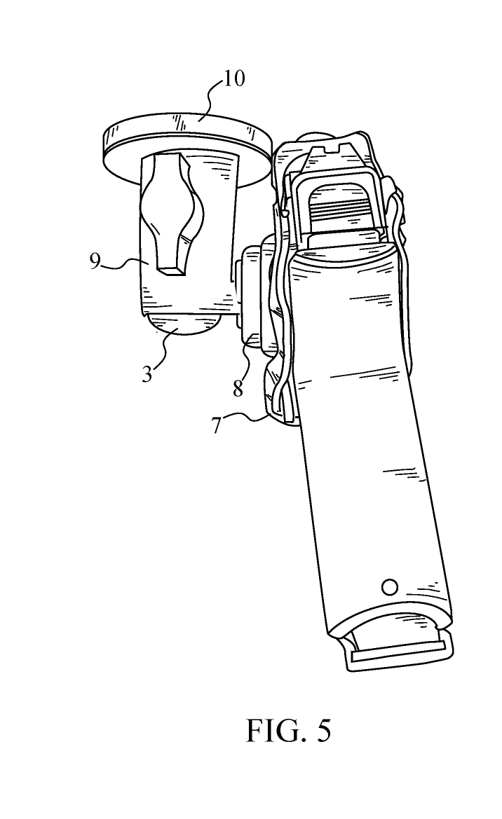

As detailed in FIG. 2, the first ball-and-socket joint 3 connects the firearm holster 1 to the holster support 9. A ball 12 of the first ball-and-socket joint 3 is mounted offset to from the mounting plate 8. The ball 12 is preferred to be centrally positioned on the mounting plate 8 to evenly distribute a weight of the holster body 7 and the firearm as the firearm holster 1 is connected to the holster support 9. A socket 13 of the first ball-and-socket joint 3 is integrated into the holster support 9. The socket 13 of the first ball-and-socket joint 3 and the mounting support 10 is oppositely positioned along the holster support 9. The ball 12 of the first ball-and-socket joint 3 is pivotably connected into the socket 13 of the first ball-and-socket joint 3, as shown in FIG. 3. Thus, the user is able to position the firearm holster 1 at a convenient angle for accessing the firearm during implementation of the present invention as the present invention is mounted to the interior of the vehicle. An exemplary angle is detailed in FIG. 5.

In one embodiment of the present invention, the mounting support 10 is a bracket 17, as detailed in FIG. 2. The bracket 17 allows the present invention to be mounted to surface of the interior for a vehicle. The mounting fixture 2 further comprises a plurality of mounting holes 11, as shown in FIG. 3. The plurality of mounting holes 11 allows for fasteners to secure the bracket 17 onto the surface within the interior of the vehicle. The holster support 9 is adjacently connected to the bracket 17. The holster support 9 is oriented normal to the bracket 17. The plurality of mounting holes 11 traverses through the bracket 17 and the plurality of mounting holes 11 are distributed around the holster support 9. Thus, the bracket 17 is able to be evenly secured to the surface of the interior for the vehicle.

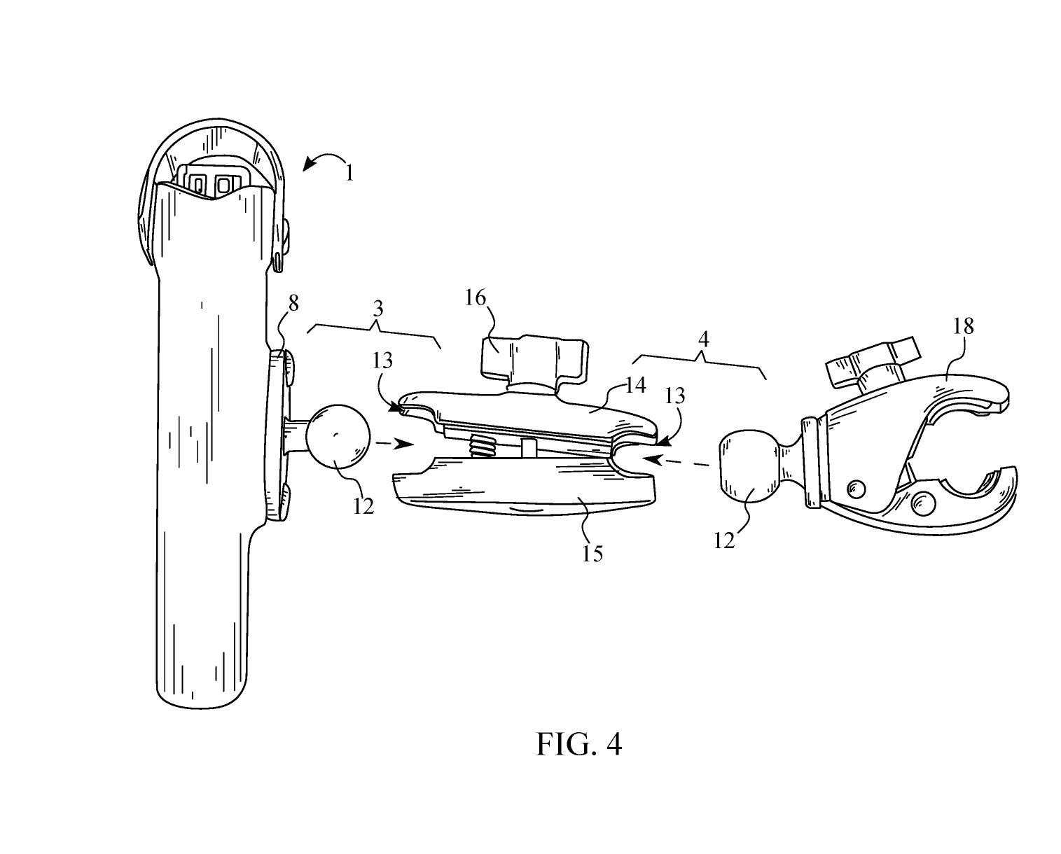

In accordance to the preferred embodiment, the holster support 9 is a first clamping portion 14, a second clamping portion 15, and a fastening mechanism 16, as detailed in FIG. 2, FIG. 3 and FIG. 4. The first clamping portion 14 and the second clamping portion 15 allow the firearm holster 1 to be disconnected from the mounting fixture 2. The fastening mechanism 16 secures the first clamping portion 14 to the second clamping portion 15 such that the first clamping portion 14 and the second clamping portion 15 are able to be pressed against or separated from each other to restrain or receive the ball 12 of the first ball-and-socket joint 3, respectively. During implementation, the ball 12 of the first ball-and-socket joint 3 is positioned between the first clamping portion 14 and the second clamping portion 15, and the fastening mechanism 16 presses the first clamping portion 14 against the second clamping portion 15, in order to restrain the ball 12 of the first ball-and-socket joint 3 from being separated from the holster support 9.

In a more specific embodiment of the present invention, the present invention comprises a shank 5 and a disk-shaped clamp retainer 6, in accordance to FIG. 2. The shank 5 and the disk-shaped clamp retainer 6 allows the holster support 9 to be engaged or disengaged with the bracket 17. The shank 5 is adjacently and centrally connected to the bracket 17. The shank 5 is oriented normal to the bracket 17. The disk-shaped clamp retainer 6 is adjacently connected to shank 5, opposite to the bracket 17, in order to offset the disk-shaped clamp retainer 6 from the bracket 17. The first clamping portion 14 and the second clamping portion 15 are positioned around the shank 5, opposite to the ball 12, as shown in FIG. 3. The disk-shaped clamp retainer 6 is enclosed between the first clamping portion 14 and the second clamping portion 15. During implementation of the present invention where the first clamping portion 14 and the second clamping portion 15 are pressed against each other with the fastening mechanism 16, the disk-shaped clamp retainer 6 prevents the first clamping portion 14 and the second clamping portion 15 from being disconnected with the bracket 17.

In another embodiment of the present invention, the present invention comprises a second ball-and-socket joint 4, in accordance to FIG. 4. Similar to the first ball-and-socket joint 3, the second ball-and-socket joint 4 connects the mounting support 10 to the holster support 9. A ball 12 of the second ball-and-socket joint 4 is mounted offset from the mounting support 10. A socket 13 of the second ball-and-socket joint 4 is integrated into the holster support 9. The socket 13 of the second ball-and-socket joint 4 and the socket 13 of the first ball-and-socket joint 3 is oppositely positioned along the holster support 9. The ball 12 of the second socket 13 joint is pivotably connected into the socket 13 of the second ball-and-socket joint 4. Similar to the first ball-and-socket joint 3, this configuration allows the ball 12 of the second ball-and-socket joint 4 to rotate within the socket 13 of the second ball-and-socket joint 4 in order to allow the user to position the holster support 9 at a preferred angle to the mounting support 10. The second ball-and-socket joint 4 allows the firearm holster 1 to have greater range of motion about the mounting support 10 such that the user is able to position the firearm holster 1 on the interior of the vehicle for convenient access.

In a more specific embodiment of the present invention comprising a second ball-and-socket joint 4, the mounting support 10 is a tubular support clamp 18, as shown in FIG. 4. The tubular support clamp 18 allows the present invention to be mounted onto a tubular-supporting structure of the interior for the vehicle, as the tubular support clamp 18 constricts around the tubular-supporting structure. The tubular support clamp 18 is connected offset to the ball 12 of the second ball-and-socket joint 4, in order to allow the ball 12 of the second ball-and-socket joint 4 to rotate freely in the socket 13 of the second ball 12 and joint socket 13.

Although the invention has been explained in relation to its preferred embodiment, it is to be understood that many other possible modifications and variations can be made without departing from the spirit and scope of the invention as hereinafter claimed.

What is claimed is:

1. A vehicle mounted holster comprises:
a firearm holster;
a mounting fixture;
a first ball-and-socket joint;
the firearm holster comprises a holster body and a mounting plate;
the mounting fixture comprises a holster support and a mounting support;
the mounting plate being laterally integrated into the holster body;
the holster support being adjacently connected to the mounting support;
a ball of the first ball-and-socket joint being mounted offset from the mounting plate;
a socket of the first ball-and-socket joint being integrated into the holster support;
the socket of the first ball-and-socket joint and the mounting support being oppositely positioned along the holster support; and
the ball of the first ball-and-socket joint being pivotably connected into the socket of the first ball-and-socket joint.

2. The vehicle mounted holster, as claimed in claim 1, wherein the mounting plate is centrally positioned along the holster body.

3. The vehicle mounted holster, as claimed in claim 1, wherein the holster support is centrally positioned on the mounting support.

4. The vehicle mounted holster, as claimed in claim 1, wherein the ball is centrally positioned to the mounting plate.

5. The vehicle mounted holster, as claimed in claim 1, comprises:
the mounting support being a bracket;
the mounting fixture further comprises a plurality of mounting holes;
the holster support being adjacently connected to the bracket;
the holster support being oriented normal to the bracket;
the plurality of mounting holes traversing through the bracket; and
the plurality of mounting holes being distributed around the holster support.

6. The vehicle mounted holster, as claimed in claim 1, comprises:
the holster support being a first clamping portion, a second clamping portion and a fastening mechanism;
the first clamping portion being pressed against the second clamping portion by the fastening mechanism; and
the ball being positioned between the first clamping portion and the second clamping portion.

7. The vehicle mounted holster, as claimed in claim 6, comprises:
a shank;
a disk-shaped clamp retainer;
the mounting support being a bracket;
the shank being adjacently and centrally connected to the bracket;
the shank being oriented normal to the bracket;
the disk-shaped clamp retainer being adjacently connected to the shank, opposite to the bracket;
the first clamping portion and the second clamping portion being positioned around the shank, opposite to the ball; and
the disk-shaped clamp retainer being enclosed between the first clamping portion and the second clamping portion.

8. The vehicle mounted holster, as claimed in claim 1, comprises:
a second ball-and-socket joint;
a ball of the second ball-and-socket joint being mounted offset from the mounting support;
a socket of the second ball-and-socket joint being integrated into the holster support;
the socket of the second ball-and-socket joint and the socket of the first ball-and-socket joint being oppositely positioned along the holster support; and
the ball of the second ball-and-socket joint being pivotably connected into the socket of the second ball-and-socket joint.

9. The vehicle mounted holster, as claimed in claim 8, comprises:
the mounting support being a tubular support clamp; and
the tubular support clamp being connected offset to the ball of the second ball-and-socket joint.

10. A vehicle mounted holster comprises:
a firearm holster;
a mounting fixture;
a first ball-and-socket joint;
the firearm holster comprises a holster body and a mounting plate;
the mounting fixture comprises a holster support and a mounting support;
the mounting plate being laterally integrated into the holster body;
the holster support being adjacently connected to the mounting support;
a ball of the first ball-and-socket joint being mounted offset from the mounting plate;
a socket of the first ball-and-socket joint being integrated into the holster support;
the socket of the first ball-and-socket joint and the mounting support being oppositely positioned along the holster support;
the ball of the first ball-and-socket joint being pivotably connected into the socket of the first ball-and-socket joint;
the mounting plate being centrally positioned along the holster body;
the holster support being centrally positioned on the mounting support; and
the ball being centrally positioned to the mounting plate.

11. The vehicle mounted holster, as claimed in claim 10, comprises:
the mounting support being a bracket;
the mounting fixture further comprises a plurality of mounting holes;
the holster support being adjacently connected to the bracket;
the holster support being oriented normal to the bracket;
the plurality of mounting holes traversing through the bracket; and
the plurality of mounting holes being distributed around the holster support.

12. The vehicle mounted holster, as claimed in claim 10, comprises:
the holster support being a first clamping portion, a second clamping portion and a fastening mechanism;
the first clamping portion being pressed against the second clamping portion by the fastening mechanism; and
the ball being positioned between the first clamping portion and the second clamping portion.

13. The vehicle mounted holster, as claimed in claim 12, comprises:
a shank;
a disk-shaped clamp retainer;
the mounting support being a bracket;
the shank being adjacently and centrally connected to the bracket;
the shank being oriented normal to the bracket;
the disk-shaped clamp retainer being adjacently connected to the shank, opposite to the bracket;
the first clamping portion and the second clamping portion being positioned around the shank, opposite to the ball; and
the disk-shaped clamp retainer being enclosed between the first clamping portion and the second clamping portion.

14. The vehicle mounted holster, as claimed in claim 10, comprises:
a second ball-and-socket joint;
a ball of the second ball-and-socket joint being mounted offset from the mounting support;
a socket of the second ball-and-socket joint being integrated into the holster support;
the socket of the second ball-and-socket joint and the socket of the first ball-and-socket joint being oppositely positioned along the holster support; and
the ball of the second ball-and-socket joint being pivotably connected into the socket of the second ball-and-socket joint.

15. The vehicle mounted holster, as claimed in claim 14, comprises:
the mounting support being a tubular support clamp; and
the tubular support clamp being connected offset to the ball of the second ball-and-socket joint.
